(19) United States
(12) Patent Application Publication
(10) Pub. No.: US 2008/0310161 A1
(43) Pub. Date: Dec. 18, 2008

(54) DIRECT-TYPE BACKLIGHT MODULE

(75) Inventor: Min-Lun Wu, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taipei (TW)

(21) Appl. No.: 12/134,207

(22) Filed: Jun. 6, 2008

(30) Foreign Application Priority Data
Jun. 12, 2007 (TW) 96209724

(51) Int. Cl. F21V 5/00; F21V 21/00

(52) U.S. Cl. 362/246; 362/249

(57) ABSTRACT

The present invention is related to a direct-type backlight module. The module includes a plurality of lamps, a plurality of lamp holders, a frame and a bezel. The frame has a bottom plate, and the lamp holders and the frame are formed into one-body. The lamp holders are disposed on the bottom plate for fixing the lamps. The frame is disposed on the bezel. The direct-type backlight module of the present invention is advantageous in having a lower fabrication cost.

### CROSS-REFERENCE TO RELATED APPLICATION

This application claims the priority benefit of Taiwan application serial no. 96209724, filed on Jun. 12, 2007. The entirety of the above-mentioned patent application is hereby incorporated by reference herein and made a part of this specification.

### BACKGROUND OF THE INVENTION

1. Field of the Invention

The present invention generally relates to a backlight module, and more particularly to a direct-type backlight module.

2. Description of Related Art

Along with the progress of modern video technology, a liquid crystal display apparatus (LCD apparatus) has been applied in cell phone, laptop, personal computer (PC), personal digital assistant (PDA) or other consumer electronic products. Since the LCD panel of an LCD apparatus itself does not have function of emitting light, a backlight module is needed to be disposed under the LCD panel to provide the LCD panel with a required light source so as to make the LCD panel display.

FIGS. 1A and 1B are 3-D diagrams of a conventional direct-type backlight module respectively from different viewing angles. Referring to FIGS. 1A and 1B, a conventional direct-type backlight module 100 includes a bezel 110, a frame 120, a plurality of cold cathode fluorescent lamps (CCFL) 130, a plurality of lamp holders 140 (only one is shown in the figures), a plurality of supporters 150 (only one is shown in the figures) and a protection cover 160. The frame 120 herein is disposed on the bezel 110, and the lamp holders 140 are disposed on the bezel 110 to support and fix the CCFLs 130.

In addition, a diffuser plate is disposed over the CCFLs 130 to increase the quality of the output light source, and the supporters 150 are disposed on the bezel 110 to support the diffuser plate. The protection cover 160 is locked and fixed on the bezel 110 to form an accommodation space to accommodate the circuit board (not shown) of the direct-type backlight module 100, wherein the protection cover 160 and the CCFLs 130 are respectively disposed on both sides of the bezel 110.

In the conventional direct-type backlight module 100, the components including the bezel 110, the protection cover 160, the frame 120, the lamp holders 140 and the supporters 150 are separately fabricated and then assembled together, and therefore it requires many dies to fabricate them, and thus it is difficult to reduce the fabrication cost. Besides, the assembling process of the conventional components requires massive labors and working hours, which would further increase the fabrication cost.

In the prior art, to assemble the direct-type backlight module 100, the frame 120, the lamp holders 140, the CCFLs 130, the supporters 150 and the diffuser plate are assembled with the bezel 110 from up to bottom. After the assembly of the direct-type backlight module 100, a display component, for example, an LCD panel is disposed over the direct-type backlight module 100. Under such an assembling architecture, if one of the CCFLs 130 or the diffuser plate gets damaged and needs to be repaired, an inversion disassembling is required to remove the LCD panel or other display components first, followed by checking the direct-type backlight module 100 and replacing some parts, which significantly lengthens the repairing and the reworking time.

### SUMMARY OF THE INVENTION

Accordingly, the present invention is directed to a low cost direct-type backlight module capable of reducing the repairing and the reworking time.

To achieve the above-mentioned or other objectives, the present invention provides a direct-type backlight module, which includes a plurality of lamps, a plurality of lamp holders, a frame and a bezel. The lamps are located over the frame. The frame has a bottom plate, and the lamp holders are integrally formed with the frame and disposed on the bottom plate. The lamp holders and the frame are connected to the lamps for fixing the lamps. In addition, the frame is disposed on the bezel.

In an embodiment of the present invention, the above-mentioned direct-type backlight module further includes a diffuser plate and a plurality of supporters, wherein the diffuser plate is disposed in the frame and located over the lamps, and the supporters are disposed on the bottom plate of the frame for supporting the diffuser plate. The supporters are, for example, pins, springs or elastic materials. Besides, the supporters can be integrally formed with the frame.

In an embodiment of the present invention, the above-mentioned frame is made of plastic.

In an embodiment of the present invention, the above-mentioned direct-type backlight module can further include a reflector disposed on the bottom plate of the frame and located between the frame and the lamps. In addition, the bottom plate of the frame can have a plurality of through holes or semi-circular cavities.

In an embodiment of the present invention, the above-mentioned lamps can be CCFLs. In addition, the direct-type backlight module can further include a set of optical films disposed on the diffuser plate, and the diffuser plate is located between the lamps and the set of optical films. The set of optical films can include a diffusion sheet, a brightness-enhancing sheet, a prism sheet or a combination thereof.

In an embodiment of the present invention, the above-mentioned frame can be assembled with the bezel along a lateral direction, the bezel can have a concave portion and the concave portion can have a plurality of through holes. The material of the bezel is, for example, aluminium.

In summary, in the direct-type backlight module of the present invention, since the lamp holders and the supporters are integrally formed with the frame, comparative smaller number of dies are required, and therefore the fabrication cost can be reduced. In the present invention, the concave portion that serves to accommodate a circuit board may be formed by directly punching the bezel, and therefore the need and the fabrication cost for a protection cover as in the case of the prior art may be avoided. In addition, the frame is assembled with the bezel along the lateral direction. When the lamp or the diffuser plate needs to be repaired, only the frame needs to be detached from the bezel along the lateral direction so as to repair or replace parts. Therefore, both the repairing and the reworking time can be significantly reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are views of a conventional direct-type backlight module respectively from different viewing angles.

FIG. 2A is a three-dimensional explosion view of a direct-type backlight module according to an embodiment of the present invention.

FIG. 2B is a perspective view of the direct-type backlight module of FIG. 2A after assembling.

FIG. 3 is a cross-sectional view of the direct-type backlight module of FIG. 2A after assembling.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

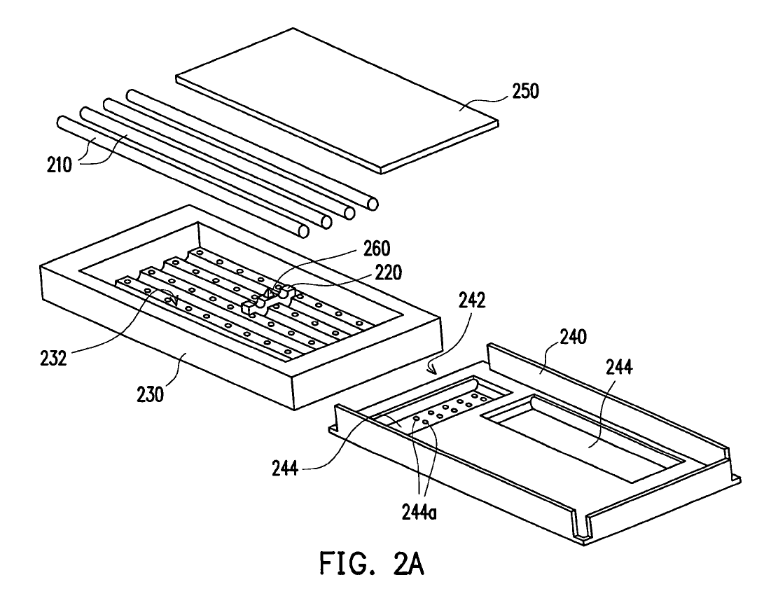

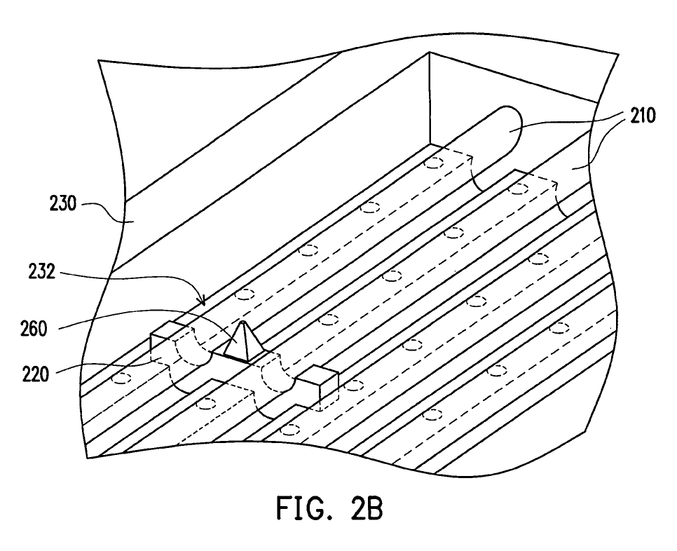

FIG. 2A is a three-dimensional explosion view of a direct-type backlight module according to an embodiment of the present invention and FIG. 2B is a perspective view of the direct-type backlight module of FIG. 2A after assembling. Referring to FIGS. 2A and 2B, a direct-type backlight module 200 of the present invention includes a plurality of lamps 210, a plurality of lamp holders 220 (only one is shown in the figures), a frame 230 and a bezel 240. The frame 230 has a bottom plate 232, and the lamp holders 220 are disposed on the bottom plate 232 for fixing the lamps 210. The lamp holders 220 are integrally formed with the frame 230. Besides, the frame 230 is disposed on the bezel 240.

Since the lamp holders 220 are integrally formed with the frame 230, after the fabrication of the frame 230 is completed, there is no need to fabricate the parts to carry the lamps 210, and therefore the number of dies required for the fabrication thereof may be effectively reduced. In addition, there is no need to assemble the lamp holders 220 with the frame 230, and therefore both labour and assembling time may be substantially reduced.

In the embodiment, the frame 230 is made of plastic, and the frame 230 is fabricated, for example, by injection molding technique. However, the present invention does not limit the material and the fabrication process of the frame 230 thereto. The lamps 210 can be CCFLs.

In order to promote the uniformity of a planar light source provided by the direct-type backlight module 200, the direct-type backlight module 200 further includes a diffuser plate 250 disposed in the frame 230 and located over the lamps 210. The direct-type backlight module 200 can include a plurality of supporters 260 (only one is shown in the figures) for supporting the diffuser plate 250, and the supporters 260 are disposed on the bottom plate 232 of the frame 230.

In the embodiment, the supporters 260 are disposed on the lamp holders 220 and integrally formed with the frame 230. Thus, it is possible to reduce the number of dies for fabricating various parts to support the diffuser plate 250 so as to reduce the fabrication cost. In addition, the supporters 260 are, for example, pins, springs, elastic materials or other suitable articles.

Note that the direct-type backlight module 200 can further include a set of optical films (not shown) to further increase the optical quality, wherein the set of optical films is disposed on the diffuser plate 250, and the diffuser plate 250 is located between the lamps 210 and the set of optical films. The set of optical films includes, for example, a diffusion sheet, a brightness-enhancing sheet, a prism sheet or a combination thereof.

Continuing to refer to FIG. 2A, the bezel 240 has an opening 242 suitable for assembling with the frame 230 along a lateral direction. When the direct-type backlight module 200 is assembled, an LCD panel (not shown) or other display parts would be disposed over the direct-type backlight module 200 to complete the assembly of an LCD apparatus (not shown). If the lamp 210 or the diffuser plate 250 of the direct-type backlight module 200 gets damaged, only the frame 230 needs to be detached from the bezel 240 along the lateral direction so as to repair or replace the damaged lamp 210 or the diffuser plate 250. Therefore, the direct-type backlight module 200 of the present invention has higher repairing efficiency and reduced reworking time.

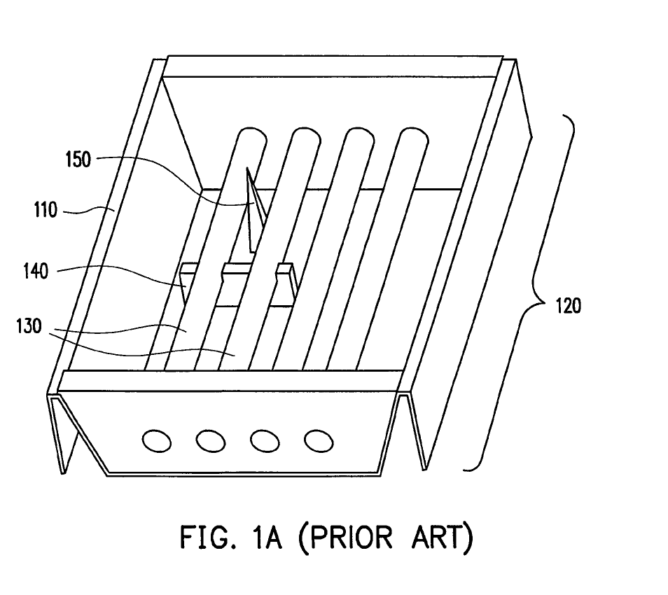

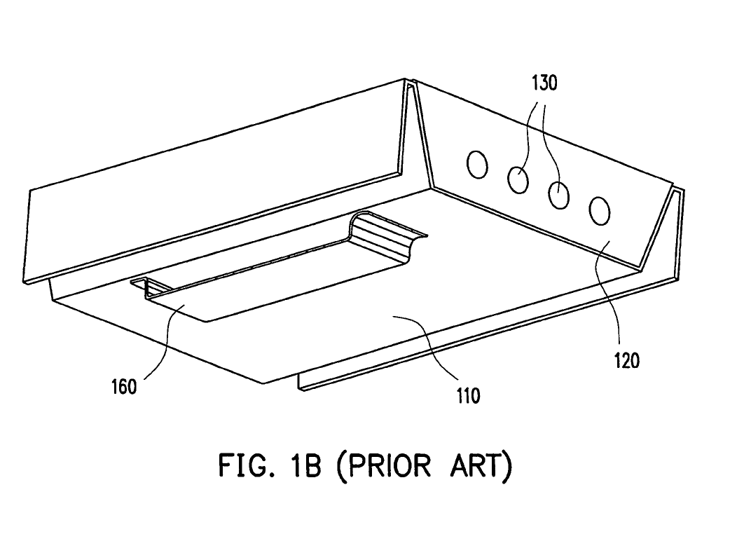

The bezel 240 is made of, for example, aluminium or other appropriate metals. A concave portion 244 is formed by punching the bezel 240, wherein the concave portion 244 has a plurality of through holes 244a. The concave portion 244 is suitable for accommodating a circuit board (not shown) or a lamp inverter or other electronic components for driving the LCD panel or controlling the lamps 210. The through holes 244a herein are helpful to dissipate the heat generated by the direct-type backlight module 200. Since the concave portion 244 and the bezel 240 can be simultaneously fabricated and the concave portion 244 can substitute a protection cover 160 in the prior art (as shown in FIG. 1B), and therefore the number of dies required for fabricating the direct-type backlight module 200 can be further reduced so as to reduce the fabrication cost.

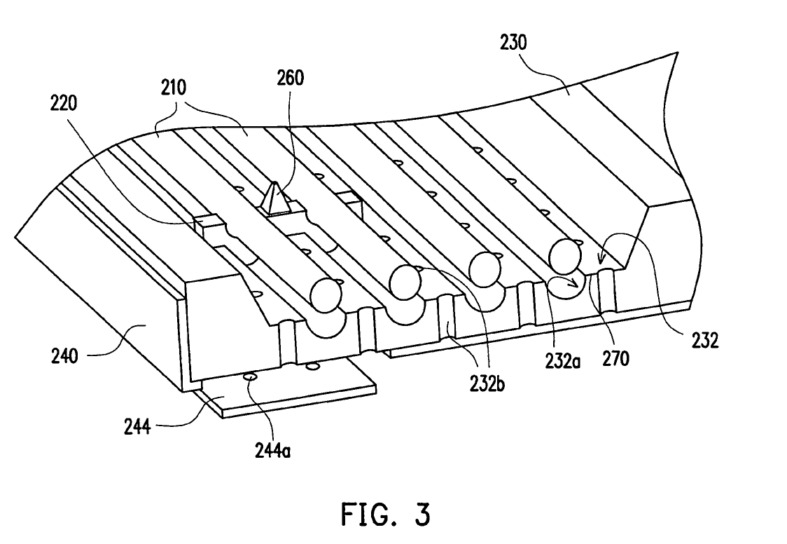

FIG. 3 is a cross-sectional view of the direct-type backlight module of FIG. 2A after assembling. Referring to FIGS. 3 and 2A, to further increase the optical quality of the direct-type backlight module 200, the direct-type backlight module 200 can further include a reflector 270, which is flatly placed on the bottom plate 232 of the frame 230 and located between the bottom plate 232 and the lamps 210 for reflecting the light emitted from the lamps 210.

The bottom plate 232 of the frame 230 has a plurality of semi-circular cavities 232a corresponding to the shapes of the lamps 210. In this way, the reflector 270 is able to entirely reflect the light emitted from the lamps 210 upwards, which not only benefits to increase the optical efficiency, but also makes the planar light source provided by the direct-type backlight module 200 more uniform. The bottom plate 232 of the frame 230 further can have a plurality of through holes 232b to facilitate dissipating heat generated by the direct-type backlight module 200.

In summary, the direct-type backlight module of the present invention at least has following advantages:

1. Since the lamp holders (or/and the supporters) are integrally formed with the frame, the number of dies required for the fabrication thereof can be reduced and the fabrication cost can also be reduced. In addition, there is no need to additionally assemble the lamp holders (or/and the supporters) with the frame, thus, the labour and the assembling time can be reduced.

2. The frame of the present invention is assembled with the bezel along a lateral direction. When an internal part of the direct-type backlight module gets damaged, only the frame needs to be taken off from the bezel for repairing or replacing the lamp or the diffuser plate. Thus, the direct-type backlight module of the present invention has higher repairing efficiency and requires shorter reworking time.

3. A concave portion can be directly formed on the bezel for accommodating an electronic part, so that the need for a protection cover as in the case of the prior art can be effectively avoided and the fabrication cost of the direct-type backlight module can be further reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A direct-type backlight module, comprising:
a frame, having a bottom plate;
a plurality of lamp holders integrally formed with the frame, disposed over the bottom plate; and
a plurality of lamps, located over the frame and connected to the lamp holders.

2. The direct-type backlight module according to claim 1, further comprising a diffuser plate disposed in the frame and located over the lamps.

3. The direct-type backlight module according to claim 2, further comprising a plurality of supporters disposed over the bottom plate of the frame to support the diffuser plate.

4. The direct-type backlight module according to claim 3, wherein the supporters are pins, springs or elastic materials.

5. The direct-type backlight module according to claim 3, wherein the supporters are integrally formed with the frame.

6. The direct-type backlight module according to claim 1, wherein the frame is made of plastic.

7. The direct-type backlight module according to claim 1, further comprising a reflector disposed over the bottom plate of the frame and located between the frame and the lamps.

8. The direct-type backlight module according to claim 1, wherein the bottom plate of the frame comprises a plurality of through holes or semi-circular cavities.

9. The direct-type backlight module according to claim 1, wherein the lamps comprise cold cathode fluorescent lamps.

10. The direct-type backlight module according to claim 1, further comprising a bezel, wherein the frame is disposed over the bezel.

11. The direct-type backlight module according to claim 10, wherein the frame and the bezel are assembled along a lateral direction.

12. The direct-type backlight module according to claim 10, wherein the bezel comprises a concave portion.

13. The direct-type backlight module according to claim 12, wherein the concave portion of the bezel comprises a plurality of through holes.

14. The direct-type backlight module according to claim 10, wherein the bezel is made of aluminium.

15. The direct-type backlight module according to claim 1, further comprising a set of optical films disposed on the diffuser plate, wherein the diffuser plate is located between the lamps and the set of optical films.

16. The direct-type backlight module according to claim 15, wherein the set of optical films comprises a diffusion sheet, a brightness-enhancing sheet, a prism sheet or a combination thereof.

17. The direct-type backlight module according to claim 1, further comprising a backboard, wherein the frame is disposed over the backboard.

18. The direct-type backlight module according to claim 17, wherein the backboard comprises a concave portion.

19. The direct-type backlight module according to claim 18, wherein the concave portion of the backboard comprises a plurality of through holes.

20. A method for assembling a direct-type backlight module, comprising:
providing a bezel or a backboard;
assembling a frame having a bottom plate with the bezel or the backboard along a lateral direction or a downward direction, wherein a plurality of lamp holders are integrally formed with the frame and disposed over the bottom plate; and
fixing a plurality of lamps over the frame through connecting the plurality of lamp holders with the plurality of lamps.

21. A method for assembling a direct-type backlight module, comprising:
providing a frame having a bottom plate, wherein a plurality of lamp holders are integrally formed with the frame and disposed over the bottom plate of the frame;
fixing a plurality of lamps over the frame through connecting the plurality of lamp holders with the plurality of lamps; and
assembling the frame with a bezel or a backboard along a lateral direction or a downward direction.
